(19) United States
(12) Patent Application Publication
(10) Pub. No.: US 2015/0070915 A1
(43) Pub. Date: Mar. 12, 2015

(54) Apparatus for Hanging Lighting Assembly

(71) Applicant: Once Innovations, Inc., Plymouth, MN (US)

(72) Inventors: Zdenko Grajcar, Orono, MN (US); Tom Fields, Minneapolis, MN (US)

(21) Appl. No.: 14/484,557

(22) Filed: Sep. 12, 2014

Related U.S. Application Data
(60) Provisional application No. 61/876,801, filed on Sep. 12, 2013.

(51) Int. Cl. F21K 99/00; F21V 23/00; F21S 8/06; F21V 29/00

(52) U.S. Cl. CPC F21K 9/1355; F21V 29/2293; F21V 23/005; F21V 23/002; F21S 8/06
USPC 362/404; 362/382

(57) ABSTRACT

A lighting assembly that has a heat. sink with an arcuate channel thereon around a circular member to receive wiring. During manufacturing the wiring is connected a printed circuit board. that engages the heat sink and is disposed through an opening in the heat sink within the arcuate channel. Then, during installation the wiring is wrapped around the circular member within the arcuate channel and held in place with an end cap. The wiring is then connected to wiring within a building allowing during which process stress and stain is transferred from the wiring to the heat sink to prevent damage to the connection point between the wiring and the printed circuit board.

### CROSS REFERENCE TO RELATED APPLICATIONS

This application claims benefit to and is based upon U.S. Provisional Patent Application Ser. No. 61/876,801 filed Sep.

12, 2013 entitled Apparatus for Hanging Lighting Assembly to Grajcar, et al, and that application is incorporated by reference in full.

### BACKGROUND

This invention relates to lighting assemblies. More specifically invention relates to an improved lighting structure for hanging a lighting assembly.

Traditionally incandescent light bulbs have been used for lighting purposes. They are placed in a ceiling mount, or fixture, typically screwed into a socket. As alternative forms of lighting have been invented the lighting industry has greatly changed. For instance more energy efficient lighting is now available, such a metal halide, CFL, solid state or LED lighting assemblies or the like.

In the typical LED lighting assembly a circuit board of some type, typically a printed circuit board is provided that contains both a plurality of light emitting diodes (LEDs) but also driving circuitry, such as AC to DC converters, PWM drives, rectifiers, capacitors, transistors, resistors and the like that are compatible with a typical wall dimming device and provide a supply current to the plurality of LEDs. As a result, electrical wiring can he directly secured to the circuit board to provide the input circuit. This allows for hard wiring of a lighting assembly straight to electrical wiring coming into a building. In other words, with the use of these lighting assemblies, sockets are no longer required.

During the installation process for hard wiring the wiring of the light assembly is typically pulled and the entire weight of the lighting assembly supported by wiring. Problems thus occur in that when pulled, soldering between the wiring and circuit board can break or become weakened, thus causing malfunctioning of the lighting assembly.

In some embodiments lighting is required that is more robust to survive harsh environments. For example, in agricultural settings feces, dust, debris and other such objects often fill the air. Often agricultural buildings are washed down with high pressure power washers to clear this dirt and debris. As a result such lighting not only needs to be able to convey heat from circuitry, but also prevent the dirt, debris and water from entering the interior of the lighting assembly. The resulting lighting assembly is often bulky and can weigh significantly more than the typical incandescent light bulb. As a result the wiring is often strained during the installation process causing breaking of the wiring. Additionally in such agricultural settings machinery is occasionally used, such as forklifts. A forklift driver that is not paying attention can sometimes drive materials on the forks into the lighting assemblies themselves or wiring, again causing additional stress and strain on the wiring increasing the chance of damaging the wiring or lighting assembly.

Therefore a principle object of the present invention is to provide a lighting assembly that minimize the stresses and strains on electrical wiring;

Yet another object of the present invention is to provide a more robust lighting assembly that can withstand harsh environments;

These and other objects, features and advantages will become apparent from the rest of the specification and claims,

### BRIEF SUMMARY OF THE INVENTION

A lighting assembly that has a heat sink that receives a circuit board having a plurality of light emitting diodes and has an opening disposed therethrough for receiving wiring. The wiring is electrically connected to the light emitting diode to provide electrical excitation to cause illumination of the light emitting diodes and is attached to the ceiling of a dwelling. The heat sink has an arcuate channel with an arcuate sidewall curving about a circular member that is enclosed by an end cap. Thus during the installation process the wiring is looped around the circular member and then held in place by the end cap causing strain from the wiring to be transferred to the heat sink to prevent, dislodging or breaking of the soldering connection between the wiring and the circuity board.

### BRIEF DESCRIPTION OF THE FIGURES

FIG. 1 is a plan side view of a lighting assembly within an agricultural dwelling.

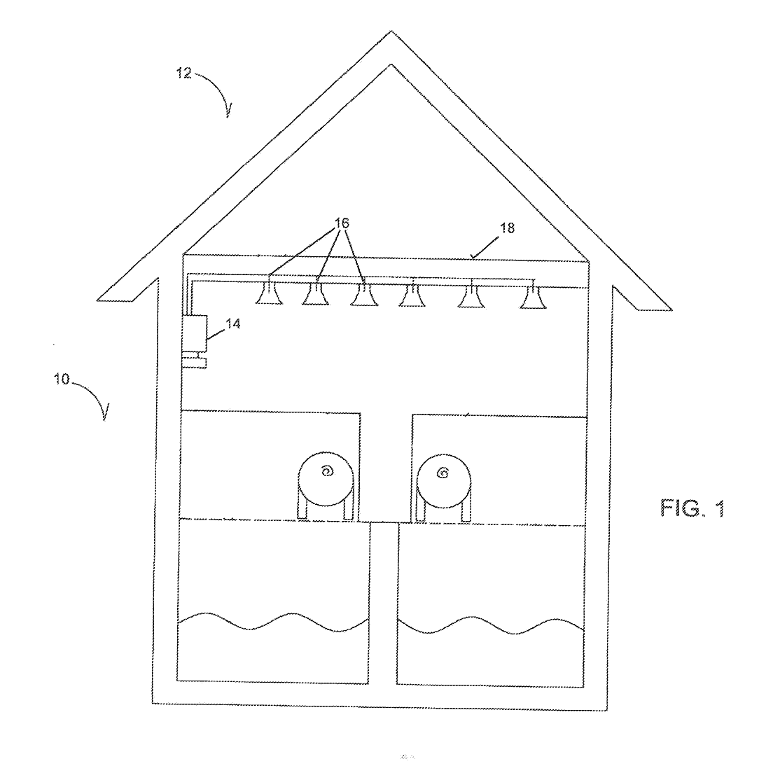

FIG. 2 is a top plan view of a heat sink and wiring of a lighting assembly.

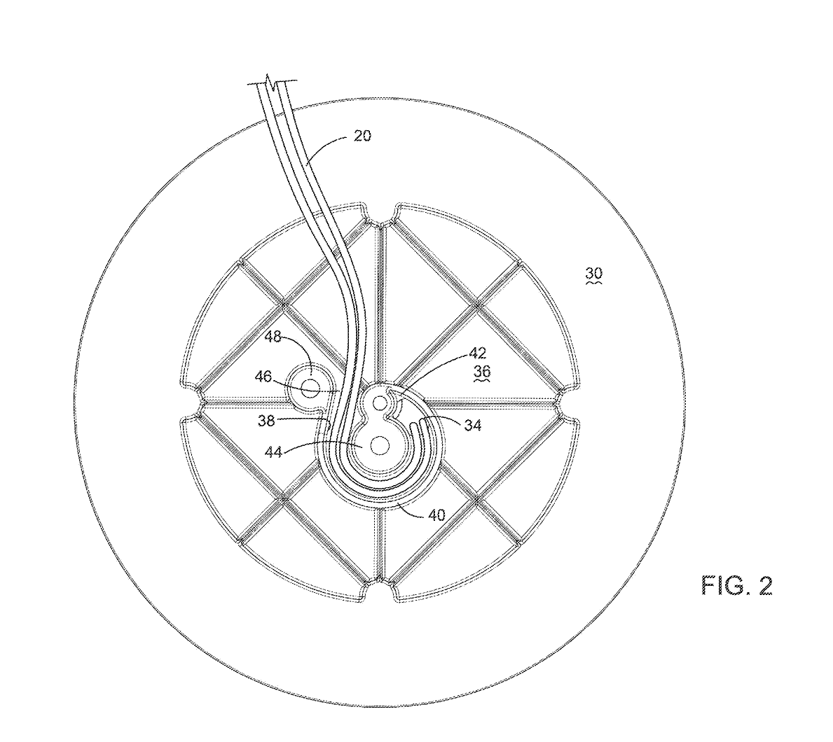

FIG. 3 is a top plan view of an end cap in a heat sink of a lighting assembly.

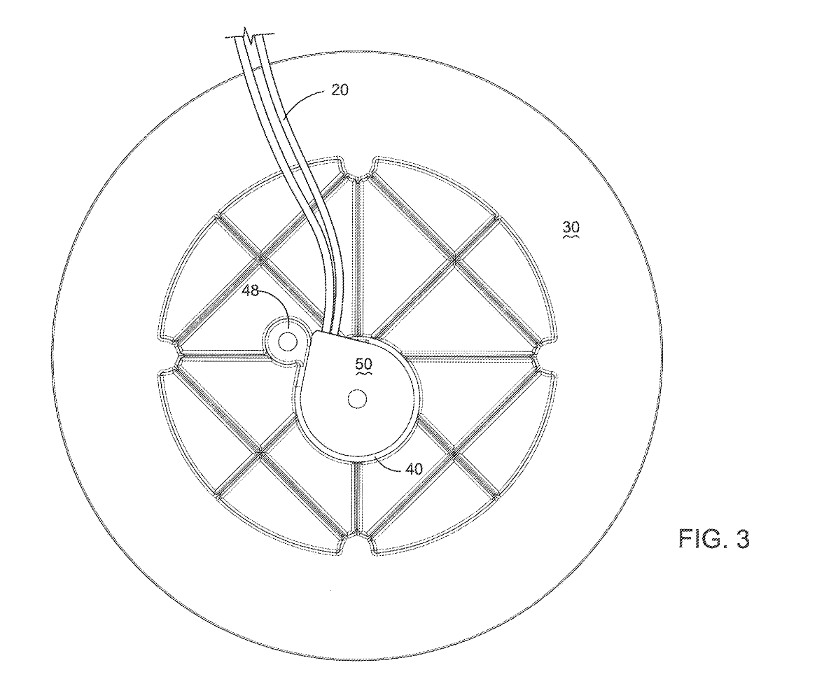

FIG. 4 is a bottom plan view of an end cap of a lighting assembly.

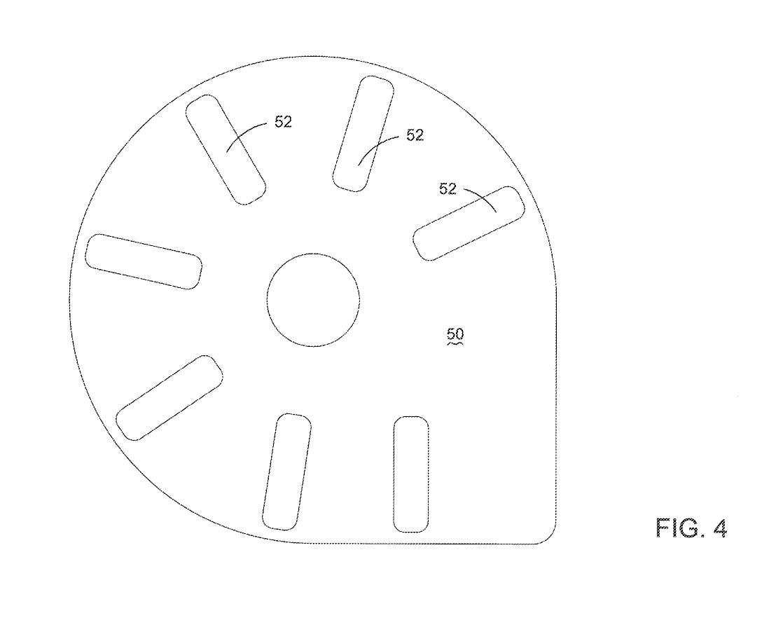

FIG. 5 is a top plan view of a heat sink, wiring and substrate of a lighting assembly.

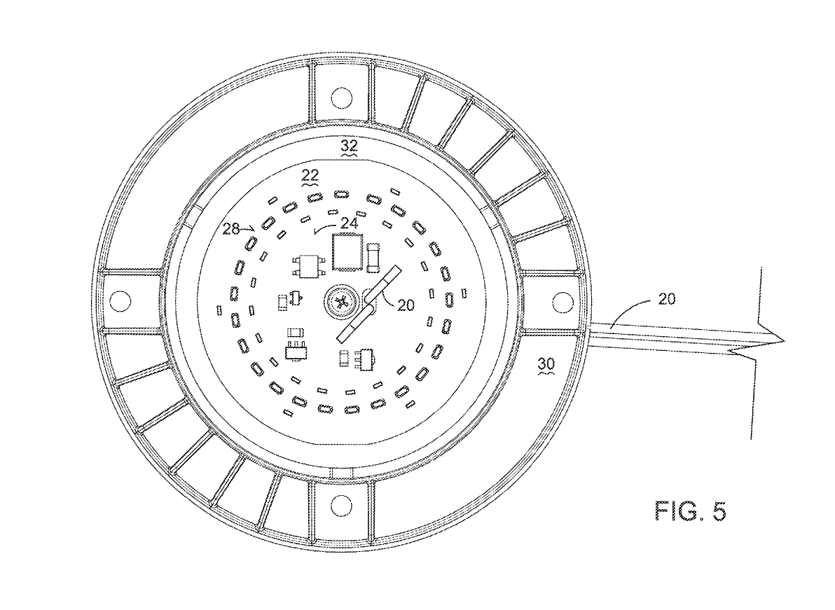

### DETAILED DESCRIPTION OF A PREFERRED EMBODIMENT OF THE INVENTION

The figures show a lighting assembly 10 that in a preferred embodiment is an LED lighting assembly used within an agricultural setting or building 12 such as a barn. Within the agricultural building 12 is a power supply 14 that provides electricity to a wiring 16 that hangs from the ceiling 18 of the building or dwelling 12. The wiring 16 can be provided in any traditional manner including but not limited to conduit bodies, whether plastic, metal or otherwise or other manners as is known in the art.

Wiring 20 of the lighting assembly 10 is engaged and electrically connected to the wiring 16 of the building to provide an electrical path for the flow oil electrical current to a circuit board 22. The circuit board 22 in one embodiment is a substrate and preferably is a printed circuit board. The circuit board 22 has driving circuitry 24 thereon for driving plurality of light emitting diodes (LEDs) 28. In one embodiment the driving circuitry 24 and LEDs 28 are presented as provided in U.S. Pat. No. 8,373,363 entitled. Reduction of Harmonic Distortion for LED Load to Grajcar and U.S. Ser. No. 12/824,215 entitled Spectral Shift Control for Dimmable AC LED Lighting also to Grajcar, both of which are incorporated in full herein.

A heat sink 30 engages the circuit board 22 such that heat is conveyed through and away from the driving circuitry 24 to the heat sink 30. The circuit board 22 is engaged along a first side 32 of the heat sink 30 and the heat sink 30 has an opening 34 disposed therethrough to a second side 36. The heat sink 30 is of size and shape to allow the wiring 20 of the lighting assembly 10 to pass, yet not allow passage of the circuit board 22. The opening 34 is located within an arcuate channel 38 having an arcuate sidewall 40 that curves from a closed first end 42 adjacent the opening 34 about a centrally located first circular member 44 or spoke to an open second end 46. Adjacent the open second end 46 is a second circular member 48 or spoke. Thus, wiring 20 is disposed through the opening 34 into the channel 38 and is wrapped around the first circular member 44 and out the open second end 46. The wiring 20 can than similarly be wrapped around the second circular member 48 or spoke.

An end cap 50 is when secured over the channel 38. In one embodiment the end cap 50 has a plurality of flanges 52 extending therefrom that are in spaced relation to one another. The flanges 52 are disposed within the arcuate channel 38 and the final flange 52 terminates within the open second end 46. The plurality of flanges 52 engage the wiring 20 in the arcuate channel 38 to prevent upward, movement, of the wiring 20 out of the arcuate channel 38. While presented as a plurality of flanges 52, a solid arcuate block that extends from either the heat sink 30 or end cap 50 that is within the arcuate channel to engage the wiring 20 could also be provided without falling outside the scope of this disclosure.

In operation the wiring 20 of the lighting assembly 10 is disposed. through the opening 34 in the heat sink 30. The wiring 20 extends from the opening 34, engages and wraps around the first circular member 44 and through the open second end 46 of the arcuate channel 38. The end cap 50 is secured to the arcuate sidewall 40 such that when the wiring 20 is pulled upwardly, the plurality of flanges 52 of the end cap 50 impede or resist the movement of the wiring 20. The wiring 20 can then be optionally wrapped around the second circular member 48 before being connected to the wiring 16 or the building. Once hung, the weight of the assembly pulls downwardly on the wiring 20 of the lighting assembly 10 and consequently the wiring 16 of the building 12. However, the wiring engages the first and second circular members 44 and 48 and the flanges 52 of the end cap 50 such that stress and strains placed on the wiring 20 is transferred to the circular members 44 and 46 and flanges 52 of the end cap 50.

In sum, by engaging and wrapping around the first and second circular members 44 and 48 the surface area upon which force is exerted increases, thus allowing more force to be dissipated into the assembly 10 improving mechanical properties. Therefore less force is transferred to the wiring 16 of the building, providing a more robust assembly 10. In addition, by utilizing the arcuate channel 38, if the opening 34 disposed through the heat sink 30 is off center, the arcuate channel 38 can be located such that the opening 34 is located within the channel 38 proving a manner in which the assembly can be centered without requiring the opening 34 to be centered during the manufacturing process. This improves manufacturing and efficiencies in manufacturing, thus providing an improvement in the art.

Thus provided is an assembly 10 having a heat sink 30 that provides a manner to transfer force placed on the wiring 20 of the lighting assembly directly to the heat sink 30. In this manner the assembly can withstand more force and if additional force is exerted on the assembly, whether downward or laterally, the assembly can better handle such forces preventing breaking of the assembly. Thus, at the very least all of the objects have been met.

While described as used in association with a lighting assembly 10 that presents light emitting diodes 28, other lighting elements that utilize wiring 16 or require to be hung are contemplated and encompassed by this disclosure. In addition, a number of implementations have been described. Nevertheless, it will be understood that various modification may be made. For example, advantageous results may be achieved if the steps of the disclosed techniques were performed in a different sequence, or if components of the disclosed systems were combined in a different manner, or if the components were supplemented with other components. Accordingly, other implementations are contemplated within the scope of the following claims.

1. A lighting assembly comprising;
a heat sink that receives a substrate having a plurality of light emitting diodes;
wiring disposed through an opening in the heat sink and electrically connected to the plurality of light emitting diodes to provide electrical excitation to cause illumination of the plurality of light emitting diodes;
said heat sink having an arcuate channel with an arcuate sidewall curving about a circular member; and
wherein the wiring engages and wraps around the circular member to transfer strain from the wiring to the heat sink.

2. The lighting assembly of claim 1 further comprising an end cap secured over the channel.

3. The lighting assembly of claim 2 wherein the end cap has a plurality of flanges in spaced relation that engages and prevents movement of the wiring.

4. The lighting assembly of claim 1 wherein the ceiling is the ceiling of an agricultural building.
